(19) United States
(12) Patent Application Publication
(10) Pub. No.: US 2014/0039081 A1
(43) Pub. Date: Feb. 6, 2014

(54) SULPHUR-CONTAINING THERMOPLASTIC POLYMERS

(71) Applicants: Otto Van Den Berg, Wilsele (BE); Filip Du Prez, Gent (BE); Sam Verbrugghe, Oostakker (BE)

(72) Inventors: Otto Van Den Berg, Wilsele (BE); Filip Du Prez, Gent (BE); Sam Verbrugghe, Oostakker (BE)

(73) Assignee: UNIVERSITEIT GENT, Gent (BE)

(21) Appl. No.: 14/111,578

(22) PCT Filed: Apr. 13, 2012
(86) PCT No.: PCT/EP2012/056767

§ 371 Date: Oct. 14, 2013

(30) Foreign Application Priority Data
Apr. 14, 2011 (EP) 11162393.0

(51) Int. Cl. C08F 128/04; C08L 41/00

(52) U.S. Cl. CPC C08F 128/04; C08L 41/00
USPC 521/149; 526/286; 526/288; 525/387; 524/547; 525/175; 525/183; 525/212; 264/523

(57) ABSTRACT

A process For the production of a thermoplastic polymer including carbon and sulphur in an atomic ration of C:S of at least 4 and at most 36 using thiol-ene addition polymerization, preferably with feedstocks obtained from renewable resources such as fatty acids from vegetable origin. The product is preferably aliphatic, meaning that at most 70% of the protons are present as aromatic hydrogen atoms and, if oxygen atoms are present in ester functions, the atomic ratio of the oxygen atoms present in ester functions relative to the number of sulphur atoms in the polymer is less than 1.0. The polymer may be used to produce a shaped article.

### FIELD OF THE INVENTION

The present invention relates to the production of a thermoplastic polymer which contains sulphur, and to its product. More particularly, the invention relates to a polythioether polymer, wherein the sulphur is present as part of the polymer backbone, which backbone is preferably aliphatic, and which polymer exhibits the desirable properties of thermoplastic materials. The thermoplastic polymer according to the present invention may be derived from renewable resources, such as from fatty acids obtained from vegetable sources.

### BACKGROUND OF THE INVENTION

Thermoplastic polymers are of extremely high economic importance. They are found in practically all objects made by mankind. Most of the conventional thermoplastic materials are derived from fossil fuel sources, such as natural gas and oil, or from byproducts thereof. These hydrocarbon sources are considered as not renewable. With on the one hand a concern for a limited supply, and on the other hand a rapidly increasing demand for energy, the need has grown for obtaining polymers at least partly from renewable resources, such that the “carbon footprint” of the polymers and the products made thereof may be reduced.

In this context for instance, polylactic acid polymers have been developed. Lactic acid, in particular the L-form, may be produced by fermentation from carbohydrate containing renewable resources. The lactic acid obtained may be polymerized into a polyester and provide a thermoplastic polymer. Also polyhydroxyalkanoates have been developed in this context. These thermoplastic materials however have significantly different physical properties than the conventional bulk thermoplastics, such as polyethylene (PE) and polypropylene (PP), and therefore are not suitable to replace them in many of their applications. So-called “Green PE”, i.e. polyethylene derived from ethanol obtained by fermentation, may be able to compete on product properties, but requires rather a complex production and purification process.

Renewable resources may be derived from agriculture, primarily from vegetable sources. Vegetable fats are a prime source of hydrocarbons in the food chain, with animal fat being a less abundant second. Chemically, fats are triglycerides, i.e. triesters of one glycerol with three fatty acid residues. An important industry has developed for processing fats, and also for converting them and their byproducts into useful derivatives. Their use as a source for polymers has remained limited, however, we believe by lack of a suitable technology.

Linseed oil has been used as a raw material in the production of oil-based paints. Thanks to the very high degree of unsaturation in the acid residues of the triglycerides of linseed oil, this oil is prone to oxidation by atmospheric oxygen, which eventually leads to cross-linking. This oxidative air-drying property has been the basis for the use of linseed oil or derivatives thereof in alkyd paints and in linoleum flooring. These applications lead to cross-linked polymers or thermosets, and therefore suffer from only limited reusability and recyclability.

Castor oil is a unique vegetable raw material, as it is the major source of ricinoleic acid, also known as 12-hydroxy-9-octadecenoic acid. This feedstock has been successfully converted into a polyamide, known as Nylon 11. It may also lead to the production of sebacic acid, or decanedioic acid, which is a building block for polyesters, alkyd resins and polyamides such as Nylon 5,10 and Nylon 6,10. The use of castor oil as a raw material in the production of thermoplastic polymers has however been impaired by its relatively limited availability. Castor oil is also the feedstock for 10-undecenoic acid or its methyl ester, methyl 10-undececoate.

Oleic acid is commercially converted by ozonolysis into azelaic acid, or nonanedioic acid, which is also a building block for polyesters, alkyd resins and for polyamides such as Nylon 6,9. Although oleic acid is available in larger quantities, the difficulties associated with the ozonolysis step as part of this process have been impeding a more widespread use of azelaic acid.

There remains therefore a need for developing other polymers derived from fatty acids or from fats.

Sulphur is used in polymer chemistry, though so far primarily in thermosets. The vulcanisation process, in which sulphur is added to hot rubber to cause cross-linking between the polymer chains and bringing a spectacular improvement of the physical properties, was key to the widespread use of rubber as an elastic structural material.

More recently, thiol-ene addition reactions, also known as “thiol-ene click reactions”, in which a thiol function adds to an alkene function, have become known and popular areas of chemical research. WO 2009/0270528 describes the polymerization of several multifunctional unsaturated urethanes, allylethers, acrylates and methacrylates with multifunctional thiols, yielding cross-linked end products exhibiting shape memory properties. Other examples of similar thiol-ene chemistry based polymeric structures include the preparation of low permeability membranes, such as described in US 2009/0253805, of sealants, such as described in WO 2009/137197, of stamps for lithography, such as in US 2009/0096136, of degradable polymeric structures for biomedical applications, such as disclosed in WO 03/031483, of liquid crystalline compositions for optical applications, such as described in GB 2277744, and of polymer electrolytes for e.g. batteries, such as disclosed in EP 824763. All of these examples involve cross-linking, and none of the materials are thermoplastics.

O. Türünc et al, in “Fatty Acid Derived Monomers and Related Polymers via Thiol-ene (Click) Additions, Macromolecular Rapid Communication, 2010, 31, no page numbers given, describes the use of thiol-ene click reactions for the production of renewable monomers. All but one of the monomers described in this article comprise a carboxylic acid function on one end, and comprise at the other end another carboxylic acid, or one or two alcohol functions. Also disclosed is a telechelic monomer ending in two alcohol functions. The article further discloses the production of polymers by esterifying the alcohol functions with the acid functions to form polyester polymers. All the polymers disclosed in this article contain oxygen atoms which are present in ester functions, and their atomic ratio of the oxygen atoms present in ester functions relative to the number of sulphur atoms in the polymer is at least 1.0.

C. Lluch et al, in “Rapid Approach to Biobased Telechelics through Two One-Pot Thiol-Ene Click Reactions, Biomacrolomecules 2010, 11, 1646-1653, describes the thiol-ene polyaddition of an excess of the allyl ester of 10-undecenoic acid with 3,6-dioxa-1,8-octanedithiol, both being telechelic building blocks, to form telechelic alkenyl-terminated oligomers with a theoretical number-average molecular weight (Mₙ^{th}) of up to 2970 g/mol. The macromonomers formed contain oxygen atoms which are present in ester and in ether functions. The atomic ratio of the oxygen atoms present in carboxylic acid ester functions relative to the number of sulphur atoms in the molecules described in this article is at least 1.0, and the atomic ratio of the oxygen atoms present in ether functions relative to the number of sulphur atoms in the molecule is at least ⅔. The use of these telechelic divinyl monomers for the tailoring of polymer structure and properties is proposed. A drawback with the chemistry proposed by Lluch is that it requires two telechelic building blocks as starting materials, which require complex chemistry for their synthesis.

There therefore remains a need for developing further polymers, more particularly thermoplastic polymers, using sulphur chemistry, in particular using thiol-ene “click” addition reactions of a thiol function to an alkene function.

The present invention aims to obviate or at least mitigate the above described problem and/or to provide improvements generally.

### SUMMARY OF THE INVENTION

According to the invention, there is provided a process for the production of a thermoplastic polymer, the polymer as produced thereby, the use of the polymer, shaped products derived from the polymer, as defined in any of the accompanying claims.

In particular, the invention provides a process for the production of a thermoplastic polymer containing carbon and sulphur in an atomic ratio of C:S of at least 4 and at most 36, wherein at most 70% of the protons are present as aromatic hydrogen atoms, the process comprising the step of step growth thiol-ene addition polymerization of at least one unsaturated thiol as monomer, thereby forming at least one thio ether (C—S—C) function, optionally in a copolymerization with another monomer, pre-polymer or oligomer selected from homo and hetero pre-polymers and oligomers containing vinyl and/or thiol end groups, the unsaturated thiol monomer preferably being aliphatic and more preferably being obtained from a fatty acid.

The applicants have found that the polymer according to the present invention may be produced from renewable resources, and hence represents a much reduced “carbon footprint” as compared to the conventional thermoplastics made from oil and natural gas. The applicants have further found that this synthesis route is relatively simple and may be operated in relatively high yield.

The applicants have found that the unsaturated thiol monomers according to the present invention, and which are type AB monomers, exhibit unexpected storage stability and could be stored up to 1 day at room temperature, up to 2 weeks at 6° C. and up to at least 6 months at −20° C. without the spontaneous formation of any polymers or oligomers.

In another embodiment, the invention provides a thermoplastic polymer containing carbon and sulphur in an atomic ratio of C : S of at least 4 and at most 36, wherein at most 70% of the protons are present as aromatic hydrogen atoms and wherein, if oxygen atoms are present in ester functions, the atomic ratio of the oxygen atoms present in carboxylic acid ester functions relative to the number of sulphur atoms in the polymer is preferably less than 1.0.

The thermoplastic polymer of the present invention is preferably obtainable by step growth thiol-ene addition polymerization of at least one unsaturated thiol as monomer, thereby forming at least one thio ether (C—S—C) function, optionally in a copolymerization with at least one other monomer or oligomer selected from a homo and a hetero pre-polymer or oligomer containing vinyl and/or thiol end groups, the unsaturated thiol monomer preferably being aliphatic and more preferably being obtained from a fatty acid, wherein up to 70% of the protons in the polymer may be present as aromatic hydrogen atoms and wherein the amount of oxygen atoms present in ester functions as part of the polymer is unlimited.

In another embodiment, the invention provides a polymer composition comprising the thermoplastic polymer according to the present invention.

In yet another embodiment, the invention provides a shaped article comprising the thermoplastic polymer according to the present invention.

The applicants have further found that the polymer according to the present invention exhibits a high thermal and chemical stability, which makes it also suitable for long lifetime products.

The applicants have also found that the polymer according to the present invention exhibits unique physico-chemical properties, such as a high printability and paintability, properties which in certain embodiments may be further improved by additional polarity introduced into the polymer molecule.

The applicants have also found that the mechanical properties of the polymer according to the present invention may be varied within a wide range, such that the polymer according to the present invention may be able to substitute bulk plastics as well as more precious engineering plastics.

The applicants have also found that the polymer according to the present invention exhibits unique solubility properties in different solvents. The applicants have further found that the polymer according to the present invention may exhibit crystallinity within a wide range, such as from 0 to 95%.

The applicants have further found that when the S atoms in the thio ether functions are oxidized to their sulphoxide (C—SO—C), and more preferably to their sulphone (C—SO₂—C) function, that thereby the polarity of the polymer is increased, which may result in an enhancement of the physical properties of the polymer, such as its crystallinity, its thermal, chemical and/or oxidative stability, its printability, its paintability, its solubility in particular solvents and/or the lack thereof.

In yet another embodiment, the invention provides a process for the production of the thermoplastic polymer according to the present invention, comprising the polymerization of at least one unsaturated thiol as monomer.

In another embodiment, the invention provides the use of the thermoplastic polymer or the polymer composition according to the present invention for the production of a shaped article.

### DETAILED DESCRIPTION

The present invention is in an embodiment directed to thermoplastic polymers, preferably aliphatic polymers. Such polymers have the advantage that they exhibit a melting temperature which is below their decomposition temperature. Thermoplastic polymers may be melted before they decompose, which brings a significant advantage in shaping the polymer into a shaped product or a shaped article.

In the embodiment of the present invention, in which the thermoplastic polymer contains oxygen atoms which are present in ester functions, the atomic ratio of the oxygen atoms present in carboxylic acid ester functions relative to the number of sulphur atoms in the polymer is at most 0.95, preferably at most 0.9, more preferably at most 0.8, even more preferably at most 0.7, yet more preferably at most 0.6, preferably at most 0.5, even more preferably at most 0.4, yet more preferably at most 0.3, and even more preferably at most 0.2. In another embodiment, also the oxygen atoms present in phosphate and/or nitrate esters are included in this atomic ratio. In a particular version of this embodiment, also the oxygen atoms present in sulphate and/or sulphite esters are included in this atomic ratio, and in a more particular version, the oxygen atoms present in all kinds of ester functions are included in this atomic ratio.

In an embodiment of the present invention, the thermoplastic polymer contains oxygen atoms present in ether functions, in which case we prefer that the atomic ratio of the oxygen atoms present in ether functions relative to the number of sulphur atoms in the polymer is less than 1.0, preferably at most 0.9, more preferably at most 0.8, even more preferably at most 0.7, yet more preferably at most 0.6, preferably at most 0.5, even more preferably at most 0.4, yet more preferably at most 0.3, and even more preferably at most 0.2.

In another embodiment of the present invention, the atomic ratio of C : S of the thermoplastic polymer is at least 5, preferably at least 6, more preferably at least 7, even more preferably at least 8, yet more preferably at least 9, more preferably at least 10, even more preferably at least 11, yet more preferably at least 12, even more preferably at least 13, more preferably at least 14, even more preferably at least 16, yet more preferably at least 18, and optionally at most 34, preferably at most 32, more preferably at most 30, even more preferably at most 28, yet more preferably at most 26, more preferably at most 24, even more preferably at most 22, yet more preferably at most 20 and even more preferably at most 18.

In yet another embodiment, the sulphur content of the thermoplastic polymer is at most 36.0% wt, preferably at most 31.0 % wt, more preferably at most 27.0% wt, even more preferably at most 24.0% wt, yet more preferably at most 22.0% wt, preferably at most 20.0% wt, more preferably at most 18.0% wt, and even more preferably at most 17.0% wt, based on the total weight of the polymer.

In an embodiment of the thermoplastic polymer according to the present invention, at most 60% of the protons are present as aromatic hydrogen atoms, preferably at most 50%, more preferably at most 40%, even more preferably at most 30%, yet more preferably at most 25%, preferably at most 20%, more preferably at most 15%, even more preferably at most 10%, yet more preferably at most 5% of the protons are present as aromatic hydrogen atoms.

In another embodiment of the thermoplastic polymer according to the present invention, at least 50% of the sulphur atoms present in the polymer molecules are present in a thioether (C—S—C), a sulphoxide (C—SO—C) and/or a sulphone (C—SO₂—C) function, preferably at least 60%, more preferably at least 70%, even more preferably at least 75%, yet more preferably at least 80%, more preferably at least 85%, even more preferably at least 90%, yet more preferably at least 95% and even more preferably at least 98% of the sulphur atoms present in the polymer molecules.

In yet another embodiment, the thermoplastic polymer according to the present invention is having a number average molecular weight Mn of at least 500 daltons or grams per mole (g/mole), preferably at least 700 daltons, more preferably at least 1000 daltons, preferably at least 3000 daltons, or even better at least 3500 daltons, more preferably at least 5000 daltons, even more preferably at least 7000 daltons, yet more preferably at least 10000 daltons, more preferably at least 20000 daltons, even more preferably at least 25000 daltons, preferably at least 30000 daltons, yet more preferably at least 50000 daltons, even more preferably at least 10⁵ daltons, optionally at most 10⁷ daltons, preferably at most 5×10⁶ daltons, more preferably at most 10⁶ daltons, yet more preferably at least 5×10⁵ daltons.

In an embodiment, the thermoplastic polymer according to the present invention is having at least one of the following characteristics:
a melting temperature Tₘ, as measured by differential scanning calorimetry (DSC), of at least 40° C., preferably at least 50° C., more preferably at least 60° C., even more preferably at least 70° C., yet more preferably at least 80° C., and preferably at least 90° C., and optionally at most 400° C., preferably at most 300° C., more preferably at most 270° C., even more preferably at most 250° C., yet more preferably at most 230° C., preferably at most 220° C., more preferably at most 210° C., even more preferably at most 200° C., yet more preferably at most 190° C.,
a glass transition temperature T_{g}, as measured by DSC, of at most 120° C., preferably at most 100° C., more preferably at most 80° C., even more preferably at most 75° C., yet more preferably at most 70° C., preferably at most 60° C., more preferably at most 55° C., even more preferably at most 50° C., yet more preferably at most 40° C., even more preferably at most 32° C., even more preferably at most 23° C. (=room T), preferably at most 0° C., more preferably at most −20° C., more preferably at most −40° C., and even more preferably at most −50° C.,
a melting temperature Tₘ which is, when expressed in degrees Kelvin (° K), in the range of 1.2-2.3 times the glass transition temperature T_{g}, also expressed in degrees Kelvin, preferably in the range 1.5-2.0, p1 semi-crystalline, as determined by DSC,
a contact angle with a droplet of water, as measured according to ISO 8296, of at most 150°, preferably at most 135°, more preferably at most 120°, even more preferably at most 105° C., yet more preferably at most 90°, and optionally at least 30°, preferably at least 45°, more preferably at least 60°, wherein 360° constitute a full circle,
a Young's modulus as measured at room temperature of about 23° C., or in the range 20-25° C., according to ASTM D-412 of at least 0.5 MPa, preferably at least 1.0 MPa, more preferably at least 5 MPa, even more preferably at least 10 MPa, yet more preferably at least 50 MPa, preferably at least 100 MPa, more preferably at least 200 MPa, even more preferably at least 300 MPa, yet more preferably at least 500 MPa, preferably at least 700 MPa, more preferably at least 800 MPa, even more preferably at least 900 MPa, yet more preferably at least 1.0 GPa, and optionally at most 10.0 GPa, preferably at most 5.0 GPa, more preferably at most 3.0 GPa, even more preferably at most 2.0 GPa, yet more preferably at most 1.5 GPa, and
a yield stress as measured at room temperature of about 23° C., or in the range 20-25° C., according to ASTM D-412 of at least 1.0 MPa, preferably at least 5.0 MPa, more preferably at least 9.0 MPa, even more preferably at least 10.0 MPa, yet more preferably at least 12.0 MPa, and optionally at most 100 MPa, preferably at most 50 MPa, more preferably at most 25 MPa, even more preferably at most 20 MPa.

In another embodiment, the thermoplastic polymer according to the present invention further comprises as part of the monomer unit a function selected from an ester function, an ether function, an imide function, a urethane function, a urea function, a thioester function, a sulphone function, a sulphoxide function and an amide function. These additional functions may further increase the polarity of the polymer. It may also improve printability of the polymer, or paintability of the polymer, or the solubility of the polymer in particular solvents, especially in solvents having a dipole moment.

In yet another embodiment, the thermoplastic polymer according to the present invention is obtainable by step growth thiol-ene addition polymerization of at least one unsaturated thiol as monomer, optionally in a copolymerization with another monomer or oligomer selected from a homo and a hetero pre-polymer or oligomer containing vinyl and/or thiol end groups. The applicants have found that this particular polymerization technique provides a polymer having particular properties, and may be able to derive the polymer from renewable resources.

In an embodiment, the polymer composition according to the present invention, comprising the thermoplastic polymer according to the present invention, may further comprise at least one other ingredient selected from the group consisting of another polymer, a foaming agent, a flam retardant, a nucleating agent, a tackifier, a filler, a lubricant, a processing aid, a plasticizer, a heat stabilizer, a UV stabilizer, an antistatic aid, and a fibre selected from carbon fibre, cellulose fibre, mineral fibre, polymer-based fibre such as fibres made from polyester, polyamide, or polyolefin, and glass fibre.

In an embodiment, the shaped article comprising the thermoplastic polymer according to the present invention or the polymer composition according to the present invention may be a pellet or a masterbatch concentrate pellet.

In another embodiment, the article according to the present invention is selected from a moulded article, a pellet, a film, a packaging element such as a packaging film, a tube, a toy, a medical tube or device component, an article intended for at least indirect and preferably direct food contact, a wall paper, foamed or non-foamed wall paper, a flooring element, such as a flooring tile, optionally a cushioned flooring element, an electrically or thermally insulating layer, a fishing lure, an artificial leather article, and at least one component or layer in any of these products.

In an embodiment of the use according to the present invention, the use comprises the step of thermo-forming, intrusion, extrusion, calendaring, casting, injection moulding, rotational moulding, blow moulding, coating, or a combination thereof.

In an embodiment of the process according to the present invention, the process comprises the step of step growth thiol-ene addition polymerization of at least one unsaturated thiol monomer. The unsaturated thiol monomer may be any possible type of unsaturated thiol monomer, and thus also comprise more than only the prescribed unsaturation and thiol function. Suitable examples are an unsaturated ester thiol, an unsaturated ether thiol, an unsaturated urethane thiol, an unsaturated thioester thiol, an unsaturated urea thiol, an unsaturated imide thiol and an unsaturated amide thiol.

In an embodiment of the process according to the present invention, the step growth thiol-ene addition polymerization step uses an initiator, which may be a thermal radical initiator, more preferably using a photo-initiator, and optionally using UV radiation or electron beam radiation.

In an embodiment of the process according to the present invention, the process comprises the step of applying a layer of a coating composition comprising the at least one unsaturated thiol monomer, the composition possibly being an ink, onto a substrate and polymerizing the at least one unsaturated thiol monomer, the substrate optionally being selected from the group consisting of wood, metal, paper and a polymeric material.

In another embodiment according to the present invention, the process comprises the step of converting an unsaturated fatty acid into a compound selected from an unsaturated thiol, an unsaturated ester thiol, an unsaturated ether thiol, an unsaturated urethane thiol, an unsaturated thioester thiol, an unsaturated urea thiol, an unsaturated imide thiol, and an unsaturated amide thiol.

In yet another embodiment according to the present invention, the process comprises the reaction of an unsaturated fatty acid, preferably an activated unsaturated fatty acid, such as the corresponding acid chloride, the acid bromide or the N-hydroxysuccinimide ester, with a thio alkyl primary or secondary amine HNR—(CH₂—)ₙ—SH or HNR—(CHR′)ₙ—CHR″—SH, whereby n may be 1, preferably n is at least 2, more preferably more than 2, even more preferably at least 4, and all R, R′ and R″ are each independently selected from the group consisting of hydrogen and hydrocarbon radicals containing at least 1 carbon atom and optionally 2-24 carbon atoms, preferably aliphatic or cycloaliphatic radicals and more preferably saturated or aromatic radicals, to form the unsaturated amide thiol.

In yet another embodiment according to the present invention, the process comprises the formation of unsaturated ethers from the reaction of an unsaturated activated ether, derived from a fatty alcohol or its corresponding alkali- or earth-alkali salt, with a double-activated ether or alkyl compound, such as those having the formula X—(CH₂)n-X, X—(CH₂)n-(O—(CH₂)n)m-O—(CH₂)n-X or R—SO₂—(CH₂)n-(O—(CH₂)n)m-O—(CH₂)n-SO₂—R whereby n may be 2, preferably n is at least 3, more preferably at least 4, even more preferably at least 5, and m may be 1, preferably m is at least 2, more preferably at least 3, even more preferably at least 4. X may be selected from the group consisting of chlorine, bromine, or iodine radicals. R may be selected from the group consisting of hydrogen and hydrocarbon radicals containing at least 1 carbon atom and optionally 2-24 carbon atoms, preferably aliphatic or cycloaliphatic radicals and more preferably saturated or aromatic radicals, to form the unsaturated activated ethers. The process may further comprise the formation of an unsaturated ether-thioacetate by the reaction of an unsaturated activated ether, preferably in a mild treatment with an alkali thioacetate or thiobenzoate, which is optionally generated in situ, preferably a derivative of potassium, sodium, lithium, and/or mixtures thereof, and preferably used in stoichiometric excess, and which generation and subsequent reaction preferably is performed in a solvent, such as methanol, ethanol or tetrahydrofuran (THF), more preferably in an aprotic solvent, for example in dimethylformamide (DMF), dimethylacetamide, N-methylpyrrolidone (NMP), or in mixtures thereof. The mild treatment is preferably performed at a temperature of at most 120° C., more preferably at most 50° C. and most preferably at most 23° C. Finally, the unsaturated ether-thioacetate may then be converted into the unsaturated ether-thiol by an aminolysis reaction of the unsaturated ether-thioacetate with an amine, preferably with piperidine or hydrazine hydrate.

In another embodiment according to the present invention, the process comprises the reaction of an unsaturated fatty acid with thio alcohol HS—(CH₂—)n-OH, whereby n is preferably at least 2, more preferably more than 2, even more preferably at least 4, to form the unsaturated ester thiol.

In yet another embodiment according to the present invention, the process comprises the conversion of an unsaturated fatty acid into an unsaturated thioacetate, and reacting the unsaturated thioacetate (i.e. an acetyl protected thiol) into the unsaturated thiol by an aminolysis reaction of the thioacetate with an amine, preferably piperidine or hydrazine hydrate.

In another embodiment according to the present invention, the process comprises the formation of the thioacetate by the reaction of an unsaturated mesylate of an unsaturated fatty acid, preferably in a mild treatment with an alkali thioacetate or thiobenzoate, which is optionally generated in situ, preferably of potassium, sodium, lithium, and mixtures thereof, and preferably used in stoichiometric excess, and which generation and subsequent reaction preferably is performed in a solvent, such as methanol, ethanol of tetrahydrofuran (THF), more preferably in an aprotic solvent, for example in dimethylformamide (DMF), dimethylacetamide, N-methylpyrrolidone (NMP), or mixtures thereof. The mild treatment is preferably preformed at a temperature of at most 120° C., more preferably at most 50° C. and most preferably at most 23° C.

In yet another embodiment according to the present invention, the process comprises the formation of the unsaturated ester of alkylsulphonic acid, such as for instance a mesylate, by the reaction of an unsaturated alcohol with an alkylsulphonyl chloride (R-SO₂—Cl), with R representing any saturated or aromatic alkyl radical containing from 1 to 24 carbon atoms, more preferably with methanesulphonyl chloride (CH₃—SO₂—Cl), also known as mesylchloride, and this in the presence of an amine, preferably a tertiary amine, more preferably triethylamine or diisopropyl ethyl amine.

In another embodiment according to the present invention, the process comprises the formation of the unsaturated alcohol from an unsaturated carboxylic acid residue containing compound by a step selected from the group consisting of (i) catalytic hydrogenation of an unsaturated acid into an unsaturated alcohol, (ii) the catalytic hydrogenation of an unsaturated alkyl ester, preferably a methyl ester, into an alcohol, the hydrogenation being homogeneously or heterogeneously catalysed, (iii) the reaction of the acid with lithium aluminium tetra hydride.

In yet another embodiment according to the present invention, the process comprises the step of obtaining an unsaturated fatty acid from a fat selected from a vegetable or animal oil or fat by hydrolysis of the glycerides in the fat or the step of obtaining an unsaturated alkyl ester, preferably the methyl ester, by alkanolysis, preferably the methanolysis of the glycerides in the oil or fat with an alkanol, preferably with methanol, or the step of pyrolysis of castor oil.

In yet another embodiment according to the present invention, the process comprises the step of fractionating an oil or fat into a fraction which is enriched in glycerides containing unsaturated fatty acid residues, the fractionation optionally be performed by using a solvent.

In yet another embodiment according to the present invention, the process further comprises the step of oxidizing at least one thio ether function present in the polymer or oligomer to a sulphoxide and/or a sulphone, preferably oxidizing substantially all the thio ether functions to the sulphoxide and/or the sulphone. The applicants have found that this step is relatively easy to perform with methods known in the art. The applicants have further found that the conversion of the thio ether function to an oxygenated function, preferably the sulphone function, may improve several of the properties of the product, as already explained above.

### EXAMPLES

### Example 1

### Synthesis of (Z)-Octadec-9-ene-1-thiol from Oleic Acid

(Z)-octadec-9-ene-1-thiol was synthesized from oleic acid in a four step synthesis process. In step 1, the carboxyl functionality in the oleic acid was reduced to the corresponding primary alcohol by the reaction with lithium aluminium tetrahydride, for two hours, in tetrahydrofurane (THF) as the solvent, at 0° C. This reaction gave a 100% yield. In step 2, the alcohol was reacted with mesylchloride in the presence of triethyl amine, in CH₂Cl₂ as the solvent, for 1 hour, at 0° C. This step gave the corresponding mesylate in a yield of 88%. In step 3, the mesylate was converted to the corresponding acetyl protected thiol by a mild treatment of the mesylate at room temperature with 1.5 equivalents of in situ generated potassium thioacetate, in dimethylformamide as the solvent, and this led to full conversion in 3 hours and a yield of 79%. A peculiar observation was that the reaction mixture gelled to a stiff gel after just 5 minutes of reaction, probably due to the formation of a potassium mesylate organogel. Addition of water at the end of the reaction dissolved the gel without further complications. In step 4, the thioacetate was deprotected by aminolysis of the thioacetate using piperidine, at room temperature, which gave the unsaturated thiol with a yield of 100%.

### Example 2

### Polymerisation of the Unsaturated Thiol of Oleic Acid

In order to evaluate the unsaturated thiol of oleic acid as a new type of thiol-ene polyaddition monomer, the pure material was irradiated under an argon atmosphere with a high pressure mercury lamp (λₘₐₓ=365 nm, 500 W) for 1 hour in the presence of 1.7 mol % 2,2-dimethoxy-2-phenylacetophenone (DMPA). The resulting material was a viscous oil. Gel Permeation Chromatography (GPC, also known as Size Exclusion Chromatography or SEC) analysis gave a relatively broad molecular weight distribution and a relatively low number average molecular weight of about 3300 g/mol, which corresponds with a degree of polymerization of 10.

### Example 3

### Starting from Undec-10-Enoic Acid

Using the process of Example 1, undec-10-enoic acid was converted to its corresponding thiol. In this example the mesylate intermediate was not purified and used directly for the preparation of the thioacetate. Deprotection by aminolysis of the thioacetate, using piperidine, led to the isolation of virtually pure thiol in quantitative yield. One minor contaminant (−0.5 mol %) was identified as the corresponding disulfide.

### Example 4

### Polymerisation of the Unsaturated Thiol from Example 3

Photo polymerization of the unsaturated thiol from Example 3 in the presence of DMPA led to the formation of a crystalline solid polymeric material. GPC (performed in chloroform) analysis indicated that the material had a number average molecular weight of 6800 g/mol. ¹H NMR spectroscopy showed that the material still contained a small amount of double bonds. Knowing that the starting material already contained a small but significant amount of bis-α-olefin functional disulfide, it was assumed that this contaminant limited the molecular weight, leading to a bis α-olefin terminated polymer. Indeed, comparison of the integral of the remaining α-olefinic =CH₂ protons with the integral of the CH₂SSCH₂ protons gave a 1:1 ratio, which confirms this hypothesis.

In addition the number average molecular weight calculated from the ratio of the integral in ¹H-NMR of the remaining α-olefinic =CH₂ protons and the integral of the CH₂SCH₂ protons (9600 g/mol) was only slightly higher than the number average molecular weight obtained by SEC (6800 g/mol). This difference is easily explained by the lower hydrodynamic volume of the prepared polymer as compared to the polystyrene standards used for the calibration.

### Example 5

### Polymerisation of the Unsaturated Thiol from Example 3 in a Purer Form

In order to obtain the unsaturated thiol from undec-10-enoic acid in a pure form, without disulfide, the material was further purified by vacuum distillation (at 2 mbar and 84° C.), taking care that at no time the pure material was exposed to air or light. Photo polymerization of this material resulted in a polymer with a markedly higher number average molecular weight of 30.000 g/mol (by SEC). The mechanical properties of this polymer were tested, and showed a Young's Modulus of 380 MPa and a Yield stress of 14 MPa.

### Example 6

### Polymerization of the Unsaturated Thiol from Example 3 in Pure Form Via Photoinitiation

The unsaturated thiol synthesized from undec-10-enoic acid which was subsequently purified via vacuum distillation, as described in Example 5, and was polymerized in bulk by using DMPA as photoinitiator. The photopolymerization was performed inside a UV-oven equipped with a hot plate. The temperature of the hot plate was set at 75° C. in order to prevent the crystallization of the formed polymer during polymerization. The intensity of the UV light used for the photopolymerization was 12 mW/cm². The photopolymerization was performed for 30 min, in various experiments resulting in polymers with number average molecular weights respectively around 30.000 g/mol or 40.000 g/mol or 50.000 g/mol or 60.000 g/mol, as determined by GPC. The molecular weight of the different polymer products made was controlled by varying the amount of the photoinitiator (in the range from 0.03 mol % to 0.08 mol %). The ¹H NMR of the polymers clearly showed the successful thiol-ene polymerization. ¹H NMR (300 MHz, CDCl₃) 2.49 (m, —CH₂S—), 1.56 (m, —CH₂CH₂S—), 1.35-12.26 (m, —CH₂CH₂CH₂S—). The melting temperature of the polymers was recorded as 90° C. via Differential Scanning calorimetry (DSC) analysis. Thermogravimetric analysis, a.k.a. thermal gravimetric analysis (TGA), showed that the synthesized polymers were stable until at least a temperature of 300° C.

### Example 7

### Polymerization of the Unsaturated Thiol from Example 3 Via Thermal Initiation

The unsaturated thiol synthesized from undec-10-enoic acid in its pure form was polymerized in bulk at 95° C. by using the 1,1′-azobis(cyclohexane-1-carbonitrile) (ABCN, obtained as V-40 from Wako Chemicals) as thermal initiator (3.7% wt or mass). Thermal polymerization of this monomer resulted in a polymer with number average molecular weight of 30.000 g/mol (by SEC).

### Example 8

### Oxidation of the Thiol-ene Polymer from Example 6 to Introduce Sulphoxides and Sulphones

The thiol-ene polymer obtained in Example 6 was dissolved in chloroform at 65° C. Subsequently glacial acetic acid and 35% hydrogen peroxide solution were added to the reaction flask to perform the oxidation. After one hour of reaction under reflux, half of the solution was transferred to a funnel and was washed with brine. The organic layer was then separated and slowly added to a methanol-water solution in order to precipitate the oxidized polymer. The second half of the reaction mixture was refluxed for one additional hour and treated in an identical manner as the first half which had been taken after only 1 hour of refluxing. The oxidation of the sulphur in the polymer chain to sulphoxide or to sulphone was controlled by the reaction time. In the first one hour of reaction time, it was found to be possible to oxidize substantially all sulphur groups to the sulphoxide form, as confirmed by FT-RAMAN (1025 cm−1;

sulphoxide specific Raman-line) and FTIR (1022 cm−1; sulphoxide specific IR absorption). In the full two hours of reaction time, substantially all sulphur groups were found to be oxidized to the sulphone form (1125 cm−1; sulphone specific Raman-line and 1132cm−1 and 1257 cm−1; sulphone specific IR absorptions), thereby forming a polysulphone polymer. The melting temperature of the polysulphone polymer was recorded as being around 170° C., showing as multiple melting peaks in a DSC analysis. TGA-analysis of the polysulphone showed no significant weight loss up to 300° C.

### Example 9

### Synthesis of N-(2-mercaptoethyl)undec-10-enamide

N-(2-mercaptoethyl)undec-10-enamide was synthesized from undec-10-enoic acid in a two step synthesis process. In step 1, the carboxyl functionality of the undec-10-enoic acid was activated with N-hydroxysuccinimide in the presence of N,N=dicyclohexylcarbodiimide, in dioxane as the solvent, at 0° C. The reaction mixture was stirred overnight. The precipitate was then removed from the solution by filtration and the solvent was evaporated to yield a white solid which was used in the further reaction as such, without further purification. In step 2, the succinimide activated undec-10-enoic acid was reacted with cysteamine in the presence of triethylamine in dichloromethane as the solvent. The mixture was stirred for 4 hours at a temperature which ranged from 0° C. to 20° C. The precipitated salt was removed by filtration and the reaction mixture was washed twice with 1 N aqueous HCl, dried with Na₂SO₄, and evaporated to dryness. The residue was further purified via recrystallization from an aliphatic alcohol, such as methanol, ethanol or isopropanol.

### Example 10

### Synthesis of N-(2-mercaptoethyl)undec-10-enamide

N-(2-mercaptoethyl)undec-10-enamide was synthesized from undec-10-enoic acid in a two step synthesis process. In the first step, the carboxylic acid function of undec-10-enoic acid was converted to an acid chloride by refluxing with thionyl chloride for two hours with the addition of a drop of dimethylformamide. The excess of thionylchloride was removed under vacuum, yielding a yellow oil that was used without further purification. In the second step the acid chloride was reacted with cysteamine in the presence of dry triethylamine in dichloromethane at 0° C. After stirring for 1 hour at 0° C. the precipitated salt was removed by filtration and the reaction mixture was washed twice with 1 N aqueous HCl, dried with Na₂SO₄, and evaporated to dryness. The residue was further purified via recrystallization from an aliphatic alcohol, such as methanol, ethanol or isopropanol to obtain the pure N-(2-mercaptoethyl)undec-10-enamide.

### Example 11

### Synthesis of N-(2-mercaptoethyl)undec-10-enamide

In this experiment, N-(2-mercaptoethyl)undec-10-enamide was synthesized from undec-10-enoic acid in a two step synthesis process. In the first step, the carboxylic acid function of undec-10-enoic acid was converted to an acid chloride by refluxing with oxalyl chloride for two hours with the addition of a drop of dimethylformamide. The excess of thionylchloride was removed under vacuum, yielding a yellow oil that was used without further purification. In the second step the acid chloride was reacted with cysteamine in the presence of dry triethylamine in dichloromethane at 0° C. After stirring for 1 hour at 0° C. the precipitated salt was removed by filtration and the reaction mixture was washed twice with 1 N aqueous HCl, dried with Na₂SO₄, and evaporated to dryness. The residue was further purified via recrystallization from an aliphatic alcohol, such as methanol, ethanol or isopropanol to obtain the pure N-(2-mercaptoethyl)undec-10-enamide.

### Example 12

### Photopolymerization of N-(2-mercaptoethyl)undec-10-enamide

The photopolymerization of N-(2-mercaptoethyl)-undec-10-enamide from examples 9, 10 and 11 was performed in degassed tetrahydrofuran, containing 5% of lithium bromide, via photoinitiation using 2,2-dimethoxy-2-phenylacetophenone (DM PA) as the photoinitiator. The intensity of the UV light used for the photopolymerization was 12 mW/cm². The photopolymerization was performed for 2 hours. Photo polymerization of the unsaturated thiol led to the formation of a viscous polymer solution. Precipitation in methanol and drying under vacuum gave a crystalline solid polymeric material.

### Example 13

### Thermally Initiated Polymerization of N-(2-mercaptoethyl)undec-10-enamide

The thermally initiated polymerization of N-(2-mercapto-ethyp-undec-10-enamide from examples 9, 10 and 11 was done in degassed tetrahydrofuran, containing 5% of lithium bromide, at 60° C., and by using azo-isobutyronitrile (AlBN) as thermal initiator (4% mole/mole). Thermal polymerization of the unsaturated thiol led to the formation of a viscous polymer solution. Precipitation in methanol and drying under vacuum gave a crystalline solid polymeric material.

### Example 14

### Synthesis of 3-(undec-10-enyloxy)-propane-1-thiol

In this experiment, 3-(undec-10-enyloxy)-propane-1-thiol was synthesized from undec-10-enoic acid in a four step synthesis. In the first step, the carboxylic acid functionality of undec-10-enoic acid was reduced to the corresponding primary alcohol. This was readily done, as already described in example 1, by lithium aluminium tetrahydride in tetrahydrofurane (THF) as the solvent at 0° C. In the second step, the obtained primary alcohol was deprotonated by NaH in THF. This solution was then added slowly to a solution of a fourfold excess of 1,3-dibromopropane in THF. The obtained compound was subsequently purified via column chromatography. In the third step, the bromo end-function was converted to the corresponding acetyl protected thiol, by in situ generated potassium thioacetate, in dimethylformamide as the solvent. In the last step, the thioacetate was deprotected by aminolysis of the thioacetate using piperidine at room temperature. The crude 3-(undec-10-enyloxy)-propane-1-thiol was purified via vacuum distillation.

### Example 15

### Synthesis of 2-(2-(undec-10-enyloxy)ethoxy)-ethanethiol

In this example 2-(2-(undec-10-enyloxy)-ethoxy)-ethanethiol was synthesized from undec-10-enoic acid in a four step synthesis. In the first step, the carboxylic acid functionality of undec-10-enoic acid was reduced to the corresponding primary alcohol. This was readily done, as already described in example 1, by lithium aluminium tetrahydride in tetrahydrofurane (THF) as the solvent at 0° C. In the second step, the obtained primary alcohol was deprotonated by NaH in THF. This solution was then added slowly to a solution of a fourfold excess of bis(2-chloroethyl) ether in THF. The obtained compound was subsequently purified via column chromatography. In the third step, the chloro end-function was converted to the corresponding acetyl protected thiol by in situ generated potassium thioacetate, in dimethylformamide as the solvent. In the last step, the thioacetate was deprotected by aminolysis of the thioacetate using piperidine at room temperature. The crude 3-(undec-10-enyloxy)-propane-1-thiol was purified via vacuum distillation.

### Example 16

### Photopolymerization of 3-(undec-10-enyloxy)propane-1-thiol

The unsaturated thiol from example 14 which was subsequently purified via vacuum distillation was polymerized in bulk by using DMPA as photoinitiator. The photopolymerization was done inside a UV-oven equipped with a hot plate. The temperature of the hot plate was set to 75° C. in order to prevent the crystallization of the formed polymer during polymerization. The intensity of the UV light used for the photopolymerization was 12 mW/cm². The photopolymerization was done for 30 min, resulting in the formation of a crystalline solid polymeric material.

### Example 17

### Polymerization of 2-(2-(undec-10-enyloxy)ethoxy)ethanethiol

The unsaturated thiol from example 15 which was subsequently purified via vacuum distillation was polymerized in bulk by using DMPA as photoinitiator. The photopolymerization was done inside a UV-oven equipped with a hot plate. The temperature of the hot plate was set to 75° C. in order to prevent the crystallization of the formed polymer during polymerization. The intensity of the UV light used for the photopolymerization was 12 mW/cm². The photopolymerization was done for 30 min, resulting in the formation of a crystalline solid polymeric material.

### Example 18

### Synthesis of N-(2-oxotetrahydrothiophen-3-yl)undec-10-enamide

For this experiment, 10-undecenoic acid was dissolved in thionyl chloride, and the solution was refluxed for 5 h at 79° C. Remaining thionyl chloride was removed via rotary evaporation with dry toluene. The final acid chloride was obtained as a yellow oil and was used without further purification.

Sodium bicarbonate was dissolved in 1,4-dioxane/water (1:1). DL-homocysteine thiolacton hydrochloride was then added slowly and the mixture was stirred during 30 minutes at room temperature. Afterwards the fatty acid chloride was added dropwise and the reaction mixture was stirred overnight. The reaction mixture was poured into brine and extracted 4 times with ethylacetate. The organic phase was dried over MgSO₄, filtrated and evaporated. The product was purified by column chromatography. The final product was obtained as a light-yellow powder.

### Example 19

### Synthesis of N-(4-mercapto-1-(octylamino)-1-oxobutan-2-yl)-undec-10-enamide

For this experiment, N-(2-oxotetrahydrothiophen-3-yl)-undec-10-enamide was dissolved in dry THF, LiBr (20% mole/mole) was added and the solution was deoxygenated using a 3-fold freeze-pump-thaw cycle. Octylamine (in a quantity of 2 equivalents) was added and the mixture was stirred until IR-analysis (disappearance of absorbtion at 1715 cm−1) indicated substantially full conversion to N-(4-mercapto-1-(octylamino)-1-oxobutan-2-yl)-undec-10-enamide. The thiol was then isolated by precipitation in cold ether, filtrated and washed to yield a white solid that could be used without further purification.

### Example 20

### Photopolymerization of N-(4-mercapto-1-(octylamino)-1-oxobutan-2-yl)-undec-10-enamide

For this experiment, N-(4-mercapto-1-(octylamino)-1-oxobutan-2-yl)-undec-10-enamide was dissolved in dry THF, LiBr (20% m/m) was added and the solution was deoxygenated using a 3-fold freeze-pump-thaw cycle. DMPA photoinitiator was added and the mixture was radiated for 19 h with 365 nm UV-light. The polymerization mixture was subsequently precipitated in cold diethylether, filtrated and washed, yielding a white polymeric substance. The number average molecular weight Mn was determined with dimethylacetamide-GPC, calibrated on PMMA standards, and found to be 9200 with a polydispersity of 1.55.

Having now fully described this invention, it will be appreciated by those skilled in the art that the invention can be performed within a wide range of parameters within what is claimed, without departing from the spirit and scope of the invention. As understood by those of skill in the art, the overall invention, as defined by the claims, encompasses other preferred embodiments not specifically enumerated herein.

1-18. (canceled)

19. A process for the production of a thermoplastic polymer containing carbon and sulphur in an atomic ratio of C:S of at least 4 and at most 36, wherein at most 70% of the protons are present as aromatic hydrogen atoms, the process comprising the step of step growth thiolene addition polymerization of at least one unsaturated thiol as monomer, thereby forming at least one thio ether function.

20. The process according to claim 19, wherein the polymerization comprises a copolymerization with another compound selected from a monomer, a pre-polymer, oligomer selected from homo and hetero pre-polymers and oligomers containing at least one end group selected from vinyl and thiol end groups.

21. The process according to claim 19, wherein the unsaturated thiol monomer is aliphatic.

22. The process according to claim 19, wherein the unsaturated thiol monomer is obtained from a fatty acid.

23. The process according to claim 19 comprising the step of converting an unsaturated fatty acid into a compound selected from an unsaturated thiol, an unsaturated ester thiol, an unsaturated ether thiol, an unsaturated urethane thiol, an unsaturated thioester thiol, an Unsaturated urea thiol, an unsaturated imide thiol, and an unsaturated amide thiol, and combinations thereof.

24. The process according to claim 19 comprising the step of obtaining an unsaturated fatty acid from a fatty feedstock selected from the list consisting of a vegetable oil, a vegetable fat, an animal oil and an animal fat, by a step selected from the hydrolysis of the glycerides in the fatty feedstock, a process comprising the step of obtaining an unsaturated all ester by alkanolysis of the glycerides in the fatty feedstock with an alkanol, and a process comprising the step of pyrolysis of castor oil.

25. The process according to claim 24, wherein the unsaturated fatty acid is obtained by a process comprising the step of the methanolysis of the glycerides in the fatty feedstock with methanol.

26. The process according to claim 6 comprising the step of fractionating a fatty feedstock selected from an oil and a fat into a fraction which is enriched in glycerides containing

27. The process according to claim 8 wherein the fractionation is performed by using a solvent.

28. The process according to claim 19 further comprising the step of oxidizing at least one thio ether function present in the polymer to a product function selected from a sulphoxide, a sulphone, and combinations thereof.

29. The process according to claim 28 comprising the step of oxidizing substantially all the thio ether functions to product functions.

30. A thermoplastic polymer containing carbon and sulphur in an atomic ratio of C:S of at least 4 and at most 36, wherein at most 20% of the protons are present as aromatic hydrogen atoms and wherein, if oxygen atoms are present in ester functions, the atomic ratio of the oxygen atoms present in carboxylic acid ester functions relative to the number of sulphur atoms in the polymer is less than 1.0.

31. The thermoplastic polymer according to claim 30 wherein at most 5% of the protons are present as aromatic hydrogen atoms.

32. The thermoplastic polymer according to claim 30 having a number average molecular weight Mn of at least 20000 daltons.

33. The thermoplastic polymer according to claim 30 which is obtainable by step growth thiol-ene addition polymerization of at least one unsaturated thiol as monomer, and wherein up to 70% of the protons in the polymer may be present as aromatic hydrogen atoms and wherein the amount of oxygen atoms present in ester functions is unlimited.

34. The thermoplastic polymer according to claim 33 wherein the polymerization comprises a copolymerization with another compound selected from a monomer, an oligomer selected from a homo and a hetero compound selected from a pre-polymer and an oligomer, the compound containing end groups selected from vinyl end groups, thiol end groups, and combinations thereof.

35. The thermoplastic polymer according to claim 33 wherein the unsaturated thiol monomer is aliphatic.

36. The thermoplastic polymer according to claim 33 wherein the unsaturated thiol monomer is obtained from a fatty acid.

37. The thermoplastic polymer according to claim 30 wherein oxygen atoms are present in ether functions, and wherein the atomic ratio of the oxygen atoms present in ether functions relative to the number of sulphur atoms in the polymer is less than 1.0.

38. The thermoplastic polymer according to claim 30 wherein the atomic ratio of C:S is at least 5.

39. The thermoplastic polymer according to claim 30 wherein the atomic ratio of C:S is at most 34.

40. The thermoplastic polymer according to claim 30 wherein at least 50% of the sulphur atoms present in the polymer molecules are present in a function selected from a thioether (C—S—C) function, a sulphoxide (C—SO—C) function, a sulphone (C—SO₂—C) function, and combinations thereof.

41. The thermoplastic polymer according to claim 30 having at least one of the following characteristics:
a melting temper Tₘ, as measured by differential scanning calorimetry (DSC), of at least 40° C.,
a glass transition temperature T_{g}, as measured by DSC, of at most 120° C.,
a melting temperature Tₘ which is, when expressed in degrees Kelvin (°K), in the range of 1.2-2.3 tines the glass transition temperature T_{g}, also expressed in degrees Kelvin,
semi-crystalline, as determined by DSC,
a contact angle with a droplet of water, as measured according to ISO 8296, of at most 150°, wherein 360° constitute a full circle,
a Young's modulus as measured at room temperature of about 23° C., according to ASTM D-412 of at least 0.5 MPa, and optionally at most 10.0 GPa,
a Young's modulus as measured at room temperature of about 23° C., according to ASTM D-412 of at most 10.0 GPa,
a yield stress as measured at room temperature of about 23° C., according to ASTM D-412 of at least 1.0 MPa, and
a yield stress as measured at room temperature of about 23° C., or in the range 20-25° C., according to ASTM D-412 of at most 100 MPa.

42. The thermoplastic polymer according to claim 30 having at least one of the following characteristics:
a melting temperature Tₘ, as measured by differentiae scanning calorimetry (DSC), of at most 400° C.,
a melting temperature T_{m p}which is, when expressed in degrees Kelvin (°K), in the range of 1.5-2.0 times the glass transition temperature T_{g}, also expressed in degrees Kelvin,
a Young's modulus as measured at room temperature in the range 20-25° C., according to ASTM D-412 of at least 0.5 MPa, and optionally at most 10.0 GPa,
a Young's modulus as measured at room temperature in the range 20-25° C., according to ASTM D-412 of at most 10.0 GPa,
a yield stress as measured at room temperature in the range 20-25° C., according to ASTM D-412 of at least 1.0 MPa, and
a yield stress as measured at room temperature in the range 20-25° C., according to ASTM D-412 of at most 100 MPa.

43. The thermoplastic polymer according to claim 30 further comprising as part of the monomer unit a function selected from an ester function, an ether function, an imide function, a sulphone function, a sulphoxide function, a urethane function, a thio ester function, a urea function, an imide function, and an amide function.

44. A polymer composition comprising the thermoplastic polymer according to claim 30 and further comprising at least one other ingredient selected from the group consisting of another polymer, a foaming agent, a flame retardant, a nucleating agent, a trackifier, a filler, a lubricant, a processing aid, a plasticizer, a heat stabilizer, a UV stabilizer, an antistatic aid, a fibre selected from carbon fibre, mineral fibre, polymer-based fibre such as fibres made from polyester, polyamide, or polyolefin, and glass fibre, and combinations thereof.

45. A shaped article comprising the thermoplastic polymer according to claim 30.

46. The shaped article according to claim 27, wherein the article is selected from a pellet and a masterbatch concentrate pellet.

47. A shaped article comprising the polymer composition according to claim 45.

48. The shaped article according to claim 47, wherein the article is selected from a pellet and a masterbatch concentrate pellet.

49. A process of using the thermoplastic polymer according to claim 30 for the production of a shaped article.

50. The process according to claim 49 comprising at least one step selected from thermo-forming, intrusion, extrusion, calendaring, casting, injection moulding, rotational moulding, blow moulding, coating, and combinations thereof.

51. A process of using the polymer composition according to claim 44 for the production of a shaped article.

52. The process according to claim 51 comprising at least one step selected from thermo-forming, intrusion, extrusion, calendaring, casting, injection moulding, rotational moulding, blow moulding, coating, and combinations thereof.
